(19) United States
(12) Patent Application Publication
(10) Pub. No.: US 2026/0022950 A1
(43) Pub. Date: Jan. 22, 2026

(54) CAP WITH ANGLED END AND EMBEDDED MAGNET

(71) Applicant: Allegro MicroSystems, LLC, Manchester, NH (US)

(72) Inventors: Rémy Lassalle-Balier, Bures sur Yvette (FR); Alexander Latham, Harvard, MA (US); Yannick Vuillermet, La Motte Servolex (FR); Peyman Moein, Annecy (FR)

(73) Assignee: Allegro MicroSystems, LLC, Manchester, NH (US)

(21) Appl. No.: 19/269,872

(22) Filed: Jul. 15, 2025

Related U.S. Application Data
(60) Provisional application No. 63/672,929, filed on Jul. 18, 2024.

(51) Int. Cl. G01D 5/20

(52) U.S. Cl. CPC G01D 5/2073

(57) ABSTRACT

Methods and apparatus for having heterogenous redundant angle sensing. In embodiments, an angle sensor has inductive sensing and magnetic sensing for a target having a magnetic portion and a metallic portion. In embodiments, the magnetic portion includes a ring magnet centered within the metallic portion, which can be referred to as a cap. In some embodiments, the target-facing side of the cap is sloped. In some embodiments, the target-facing side of the cap and the ring magnet are sloped.

### CROSS REFERENCE TO RELATED APPLICATIONS

The present application claims the benefit of U.S. Provisional Application No. 63/672,929, filed on Jul. 18, 2024, which is incorporated herein by reference.

### BACKGROUND

Magnetic field sensors can be used in a variety of applications. In one application, a magnetic field sensor can be used to detect an angle of rotation of a ferromagnetic object. In another related application, a magnetic field sensor can be used to sense a rotation (e.g., a continuous or discontinuous rotation) of a ferromagnetic object.

Within a magnetic field sensor, planar Hall elements and vertical Hall elements are known types of magnetic field sensing elements. A planar Hall element tends to be responsive to magnetic field perpendicular to a surface of a substrate on which the planar Hall element is formed. A vertical Hall element tends to be responsive to a magnetic field parallel to a surface of a substrate on which the vertical Hall element is formed. Also, within a magnetic field sensor, various types of magnetoresistance elements are known. Most types of magnetoresistance elements tend to be responsive to magnetic fields parallel to a surface of a substrate on which the magnetoresistance element is formed.

### SUMMARY

Embodiments of the disclosure provide methods and apparatus for magnetic field angle sensing including heterogeneous redundant sensing in the form of magnetic and inductive field sensing to provide redundant angle sensing. A target can include a magnetic portion and a metallic portion, for example, a printed circuit board (PCB) can include inductive coils and a magnet. In embodiments, redundant angle sensing can include magnetic angle sensing with sensing elements that can include, for example, one or more of TMR, planar Hall elements, vertical Hall elements, barycenter magnetic sensor, and/or fluxgates, etc., and inductive sensing with transmit and receive coils.

In one aspect, a redundant sensing system IC package to determine angular position of a target comprises: an inductive sensing system, comprising: a main coil to direct a magnetic field at the target for inducing eddy currents in the target; a receive coil having a butterfly configuration, wherein the receive coil has sine and cosine coils for detecting a reflected field from the target wherein each of the sine and cosine coils is configured such that an asymmetric reflected field from the target seen by the sine and cosine coils corresponds to an air gap between a surface of the target in relation to the main coil and the receive coil; a magnetic field sensing system to detect the angular position of the target using magnetic field sensing elements, wherein the target has a magnetic portion affecting the magnetic field sensing elements and a metallic portion in which the eddy currents are induced, and wherein the IC package is located in relation to the receive coil.

In another aspect, a redundant sensing system IC package to determine angular position of a target comprises: an inductive sensing system, comprising: a main coil to direct a magnetic field at the target for inducing eddy currents in the target; a receive coil having a butterfly configuration, wherein the receive coil has only a sine or cosine coil for detecting a reflected field from the target wherein the sine or cosine coil is configured such that an asymmetric reflected field from the target seen by the sine or cosine coil corresponds to an air gap between a surface of the target in relation to the main coil and the receive coil, wherein the receive coil is configured to provide a linear approximation of the target angle for short stroke movement of the target; a magnetic field sensing system to detect the angular position of the target using magnetic field sensing elements, wherein the target has a magnetic portion affecting the magnetic field sensing elements and a metallic portion in which the eddy currents are induced, and wherein the IC package is located in relation to the receive coil.

In another aspect, a method for redundant sensing using an IC package to determine angular position of a target comprises: employing an inductive sensing system that comprises: a main coil to direct a magnetic field at the target for inducing eddy currents in the target; and a receive coil having a butterfly configuration, wherein the receive coil has sine and cosine coils for detecting a reflected field from the target wherein each of the sine and cosine coils is configured such that an asymmetric reflected field from the target seen by the sine and cosine coils corresponds to an air gap between a surface of the target in relation to the main coil and the receive coil; and employing a magnetic field sensing system to detect the angular position of the target using magnetic field sensing elements, wherein the target has a magnetic portion affecting the magnetic field sensing elements and a metallic portion in which the eddy currents are induced, and wherein the IC package is located in relation to the receive coil.

In another aspect, a device comprises: a magnet portion; and a cap comprising a metallic material, wherein the cap has an end with a slant, wherein the magnet portion is at least partially embedded in the cap. In another aspect, a method comprises: providing a magnet portion; and a cap comprising a metallic material, wherein the cap has an end with a slant, wherein the magnet portion is at least partially embedded in the cap

### BRIEF DESCRIPTION OF THE DRAWINGS

The foregoing features of this disclosure, as well as the disclosure itself, may be more fully understood from the following description of the drawings in which:

FIG. 1A is a block diagram of an angular position sensing system having redundant sensing;

FIG. 1B is a block diagram of components of an angular position sensing system having redundant;

FIG. 1C is a high level block diagram of an example inductive sensing system that can form a part of the systems of FIGS. 1A and 1B;

FIG. 2 is a block diagram of an example implementation of the inductive sensing system of FIG. 1C;

FIG. 3 is a schematic representation of a target having a cut end that is conductive for which angular position can be sensed;

FIG. 4 is a graphical representation of the magnetic fields created when eddy currents are generated in a cut end surface of the target of FIG. 3 that can be used to determine an angle or rotation of the cut for the target;

FIG. 5 is a schematic representation of a target and a field reflected by the target;

FIG. 5A is a schematic representation of a target and a field reflected by the target that is rotated from its position in FIG. 5;

FIG. 6A is an example implementation of a main coil that can form at part of an angular position sensor using eddy currents;

FIG. 6B is an example implementation of a first pick up coil that can form at part of an angular position sensor using eddy currents;

FIG. 6C is an example implementation of a second pick up coil that can form at part of an angular position sensor using eddy currents;

FIG. 6D is a schematic representation of an example configuration for the main coil of FIG. 6A, the first pick up coil of FIG. 6B, and the second pick up coil of FIG. 6C;

FIG. 7 is a top view of example transmit and receive coils;

FIG. 7A is a top view showing the receive coils of FIG. 7;

FIG. 8A shows constituent cosine coil signals, FIG. 8B shows normalized cosine signals, and FIG. 8C shows vertical error in cosine for the configuration of FIG. 7;

FIG. 9A shows constituent sine coil signals, FIG. 9B shows normalized sine signals, and FIG. 9C shows vertical error in sine for the configuration of FIG. 7;

FIG. 10A shows vertical cosine error and FIG. 10B shows vertical sine error for a single coil per channel, and FIG. 10C shows output angle error for the configuration of FIG. 7;

FIG. 11A shows an example receive coil configured to provide third harmonic compensation with a first pair of coil loops emphasized, FIG. 11B shows a second pair of receive coil loops emphasized, FIG. 11C shows an exploded view of the example receive coil configuration and an example transmit coil; FIG. 11D shows coils offset at +/− thirty degrees for a total of 60 degree offset for third harmonic compensation; and FIG. 11E shows a coil configuration in a PCB layer;

FIG. 11F shows a coil configuration with an example tilt angle and FIGS. 11G and 11H show the respective butterfly coils separately;

FIG. 12A shows constituent coil cosine signals and FIG. 12B shows normalized cosine signals, and FIG. 12C shows vertical cosine error for the receive coil configuration of FIG. 11A;

FIG. 13A shows constituent coil sine signals and FIG. 13B shows normalized sine signals, and FIG. 13C shows vertical sine error for the receive coil configuration of FIG. 11A;

FIG. 14A shows vertical cosine error, FIG. 14B shows vertical sine error and FIG. 14C shows output angle error for the receive coil configuration of FIG. 11A;

FIG. 15A shows an example receive coil configuration with third and fifth order harmonic compensation;

FIG. 15B shows a first set of butterfly coils in FIG. 15A connected in series and FIG. 15C shows the other set of butterfly coils in FIG. 15A connected in series, and FIG. 15D shows a PCB layer coil implementation;

FIG. 15E shows a coil configuration having first and second tilt angles, and FIGS. 15F and 15G show the coils and tilt angle separately for a single PCB layer embodiment;

FIG. 16A shows constituent coil cosine signals, FIG. 16B shows normalized cosine signals, and FIG. 16C shows vertical cosine error for the receive coil configuration of FIG. 15A;

FIG. 17A shows constituent coil sine signals, FIG. 17B shows normalized sine signals, and FIG. 17C shows vertical sine error for the receive coil configuration of FIG. 15A;

FIG. 18A shows vertical cosine error, FIG. 18B shows vertical sine error, and FIG. 18C shows output angle error for the receive coil of FIG. 15A;

FIG. 19A shows amplitude versus air gap and FIG. 19B shows sine and cosine offset versus airgap for an example sensor;

FIG. 20A is a cross-sectional view and FIG. 20B is a partially transparent isometric view of an example target having a cylindrical puck magnet and a cap;

FIGS. 20C and 20D show an example cap configuration;

FIG. 21A is a cross-sectional view and FIG. 21B is a partially transparent isometric view of an example target having a cylindrical puck magnet and a cap where the magnet and cap combine to form a slant surface having a slant angle θ;

FIG. 22A shows an example inductive sensing coil configuration having a transmit coil and first and second receive coils, FIG. 22B, shows the transmit coil and only the first receive coil and FIG. 22C shows the transmit coil and only the second receive coil;

FIG. 23A shows inductive sensor angle error over PCB tilt and FIG. 23B shows misplacement for the example sensor and coil configuration of FIG. 24C below;

FIG. 24A shows an example sensing system having a butterfly coil configuration with a first (top) coil and a second (bottom) coil and a magnetic sensor IC package placed inside, e.g., the center, of the coils.

FIG. 24B shows a butterfly coil configuration with harmonic compensation and a magnetic sensor IC;

FIG. 24C shows first and second butterfly coils configured to provide a coil-free region in which a magnetic sensor IC 2426 can be placed;

FIGS. 24D and 24E show an IC positioned in relation to coils;

FIGS. 25A and 25B are graphical representations of angle error over misplacement (FIG. 25A) and tilt (FIG. 25B) of the sensor shown in FIG. 24C;

FIG. 25C shows an example half moon target and coils;

FIG. 26 shows an example sensor IC package positioned in relation to a target; and

FIG. 27 is a schematic representation of an example computer that can perform at least a portion of the processing described herein.

### DETAILED DESCRIPTION

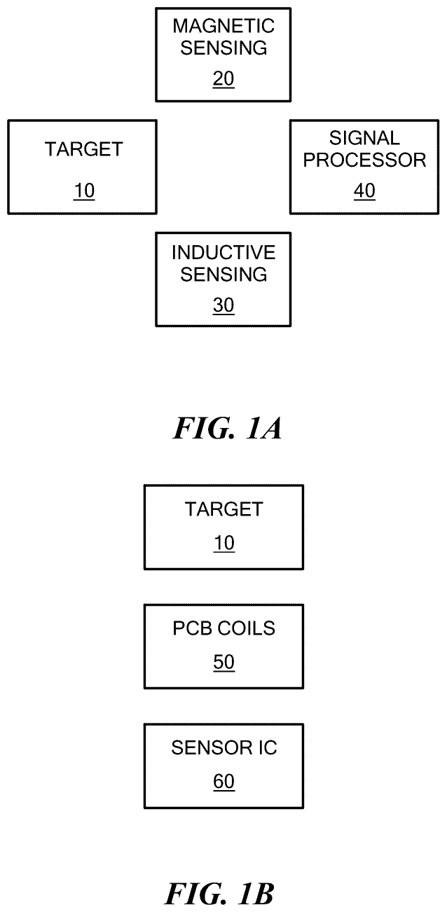

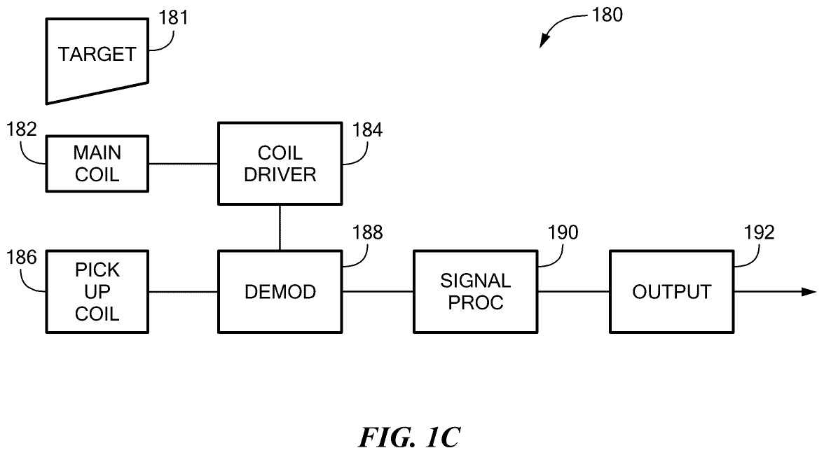

FIG. 1A shows an example heterogeneous redundant angle sensing system including a target 10 positioned in relation to a magnetic sensing system 20 and an inductive sensing system 30. A signal processing module 40 can process information from the magnetic and inductive sensing systems 20, 30 for heterogeneous redundant sensing.

FIG. 1B shows an example implementation of the angle sensing system of FIG. 1A in which the target is positioned in relation to coils 50, which may be provided on a printed circuit board (PCB) to generate signal transmission to excite the target 10 and receive coils to sense the target as part of the inductive sensing system. A sensor IC package 60 is also positioned in relation to the target 10 and the coils 50 to provide processing of the magnetic and/or inductive signals for determining angular position of the target. U.S. Pat. Nos. 10,782,152 and 9,797,746, which are both incorporated herein by reference, show example sensing systems for processing target data.

FIG. 1C shows an angle sensor system 180 that uses inductive sensing for the inductive sensing system 30 of FIG. 1A including transmit and receive coils. The target 181 is located in proximity to the angle sensor to enable determination of angular position. In one embodiment, the target 181 comprises a cylinder with an at least partially conductive end surface proximate the angle sensor, and more particularly, a main coil 182. A coil driver module 184 energizes the main/transmit coil 182 with a signal that results in a signal reflected from the target 181. The reflected signal is received by a pick up/receive coil module 186 and demodulated by a demodulator module 188. In embodiments, the pick up coil module 186 includes first and second coils arranged to enable sine and cosine signals to be generated and processed by a signal processing module 190. The signal processing module 190 can determine the angular position of the target so that an output module 192 can output a signal corresponding to angular position of the target 181.

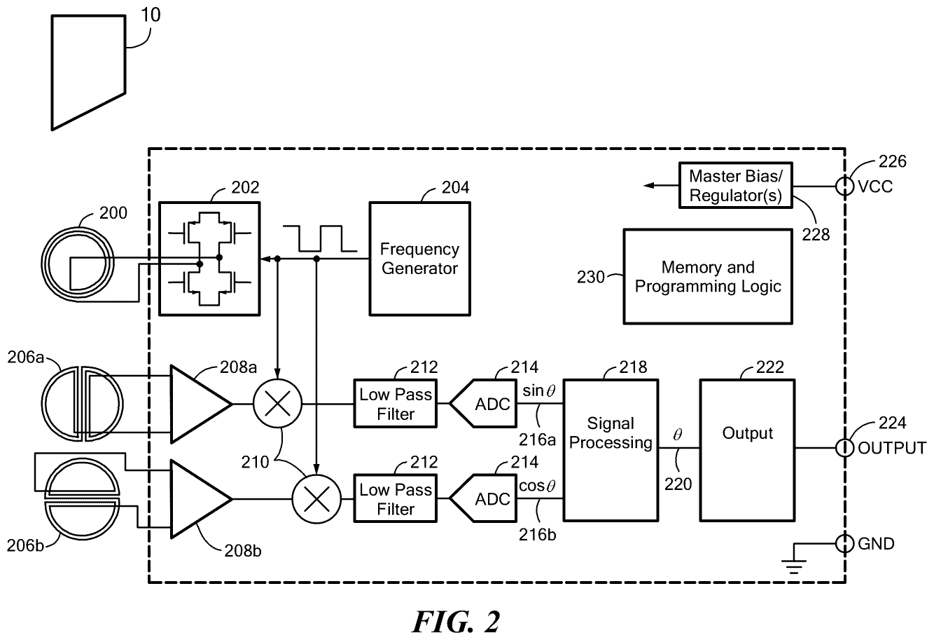

FIG. 2 shows an example implementation of the inductive system 180 of FIG. 1C. A main coil 200 is driven by a coil driver 202 coupled to a frequency generator 204, for example. In embodiments, coil driver 202 supplies current to the main coil 200 to generate a magnetic field. An alternating current may be used so that the main coil 200 produces alternating magnetic fields (i.e., magnetic fields with magnetic moments that change over time). The field generated by the main coil 200 causes a reflected signal to be generated by the target 10 that is received by first and second pick up coils 206a,b and amplified by amplifiers 208a,b. In embodiments, the first coil 206a is configured to generate a sine signal and the second coil 206b is configured to generate a cosine signal. As described more fully below, additional coils can be positioned relation to each other to provide harmonic compensation and reduce residual error. The amplified pick up signals for the first and second coils 206a,b are demodulated 210 to bring the high frequency signal down to DC since the magnetic signal will be at the same frequency as that in the main coil, so one uses that same frequency to demodulate down to DC. The sine and cosine signals can be filtered 212, such as with low pass filters 212, and digitized by analog-to-digital converters (ADC) 214.

The digitized sine and cosine signals 216a,b are provided to a signal processing module 218 to generate an angular position signal 220 that corresponds to the angular position θ of the target 10. In embodiments, the arc tangent function, e.g., tan⁻¹ sin θ/cos θ, can be used to determine angular position θ. In some embodiments, angular position processing is performed in the digital domain. In other embodiments, angular position processing is performed in the analog domain. The angular position signal can be received by an output module 222. In embodiments, the output module can perform signal normalization, linearization, calibration, and the like, of the position signal prior to output from the IC, for example, on an output pin 224.

The IC can include an IO pin 226 configured to receive a voltage supply signal VCC. A regulator module 228 can provide voltage signals throughout the IC and provide master bias and other functionality. The IC can further include memory 230 to store programming logic, provide volatile and/or non-volatile memory, and the like.

In example embodiments, the main coil 200 is energized with a signal having a frequency in the range of about 1 to about 20 MHz. It is understood that other frequencies can be used to meet the needs of a particular application, and going to higher frequency can increase signal strength

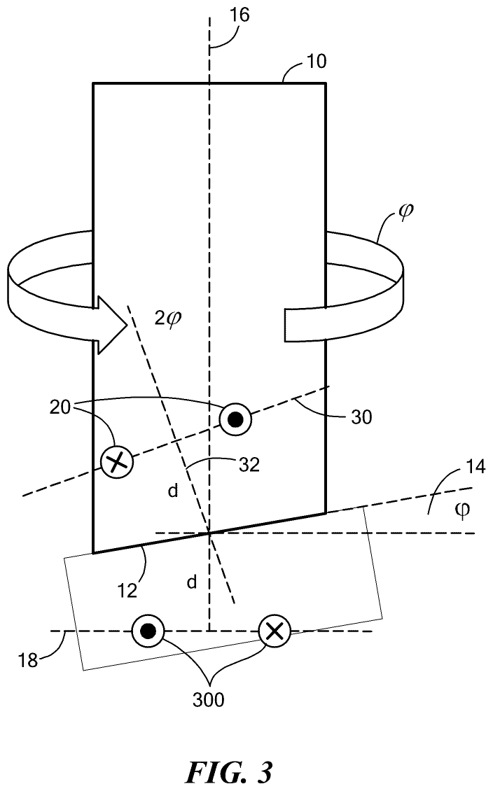

FIG. 3 shows an example target 10 in the form of a cylinder having at an end 12 that is cut at an angle 14 shown as q. In one embodiment, the angle 14 is defined in relation to a longitudinal axis 16 of the cylinder that is perpendicular to a plane/axis 18 in which the main coil 300 resides. The cut end 12 of the target is at least partially conductive. In some embodiments, at least the end 12 of the target is formed from a conductive material, such as aluminum. In some embodiments, a conductive material can be applied to the end 12 of the target, which may be formed from a conductive or non-conductive material. The cylinder 10 rotates about its longitudinal axis 16 with an angular position defined by θ while the main coil 300 radiates a magnetic field toward the end 12 of the cylinder. A mirrored coil 20 is shown at a distance from the end 12 of the target at a given location. It is understood that the mirrored coil is an idealized model, which assumes a perfect conductor and vacuum, that can be used to model the reflected field from the conductive target end. It is understood that an X in a circle indicates a current into the paper and a dot in a circle indicates a current coming out of the paper. An example range for the cut angle is about +/−45 degrees. In many embodiments, the cut angle is between about 1 and 15 degrees.

The end 12 of the target, at the axis 16 of the target, is located a distance d from the plane 18 of the main coil 300. The mirror coil 20 is located in a plane 30 that is bisected by a segment 32 extending perpendicularly from the mirror coil plane 30 such that an angle formed by segment 32 and the target longitudinal axis 16 is 20. The segment 32 extends a distance d from the end 12 of the target at the axis 16 to the plane 30 of the mirror coil 20.

As noted above, the main coil 300 causes a reflected field to emanate from the target 10. The reflected field can be modeled as the mirror coil 20. Pick up coils, as described above and below, can receive the reflected field and generate an angular position signal for the target 10.

In accordance with Maxwell's equations, the magnetic field from the main coil 300 induces Eddy currents in the conductive surface 12 of the target. In addition, an ideal conductor keeps AC magnetic flux lines from crossing its boundary which results in symmetry of the main and mirrored coil across the boundary of the conductor.

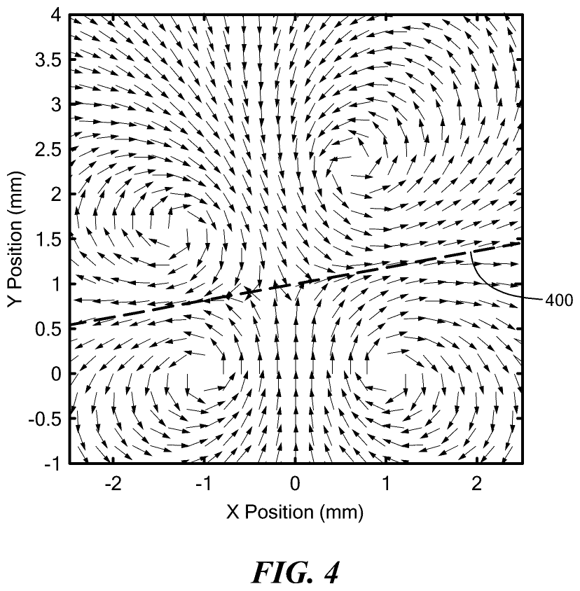

FIG. 4 shows the combined field lines from a main coil and from a ‘mirrored coil’, which is located according to FIG. 3. The resulting fields never cross the target boundary 400. In operation, the main coil 300 applies a field on the target 10 that causes eddy currents to flow within the target. These eddy currents create their own magnetic fields that can be modeled as the mirror coil 20. In practice, currents will only flow on the surface of the target, but the effect will be as if the currents were flowing like mirror coil 20. It should be noted that Faraday's Law says that the voltage induced in a closed loop is proportional to the rate of change of the magnetic flux that the loop encloses. This means that an AC magnetic field crossing a sheet induces a voltage in the sheet. However, a perfect conductor cannot have a voltage induced on it, so, instead, currents develop on the surface to reject the magnetic field from going through the conductor. This is what one will see in a finite element simulation. However, one can model this behavior through symmetry. Basically, there is no field crossing the boundary by having symmetric coils (same size and current) across the boundary as shown in FIG. 3. That is not where the actual currents flow, as there is no magnetic field inside the conductor, but rather models the magnetic fields external to the conductor as if those surface currents were flowing. That means that in FIG. 4, the fields below the dashed line 400 are the ones actually seen, and the ones above it will not exist in reality.

It will be appreciated that the cut angle provides an optimization. As one increases the cut angle, the angle of the reflected field increases, thereby increasing the differential seen by the pick-up coils, but one also has to increase distance d in order to keep the edge of the target from hitting the sensor, which reduces the field seen. In example embodiments, around 7.5 degrees provides the largest output signal for a 1 mm air-gap from the lowest point of the target to the sensor.

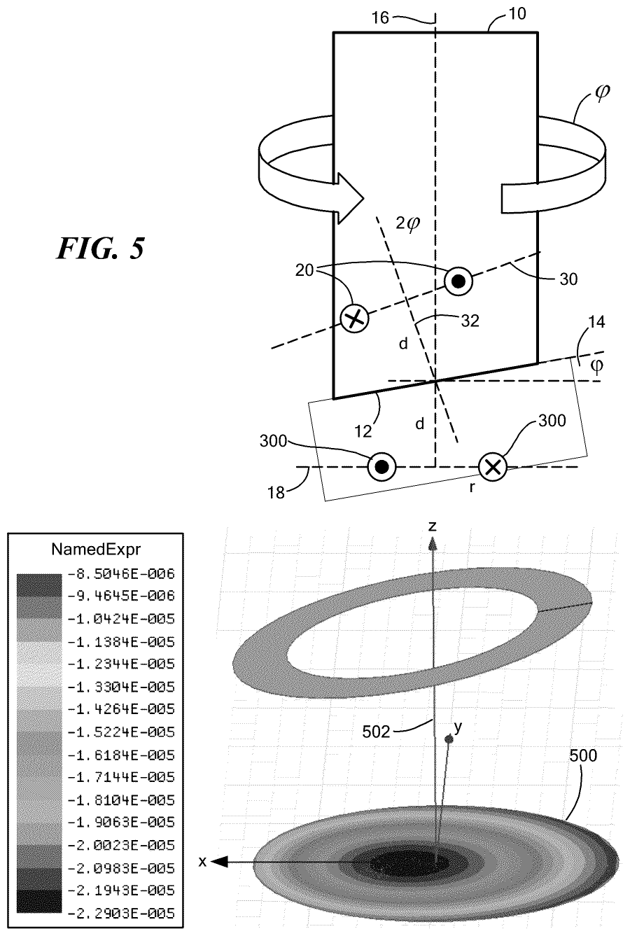

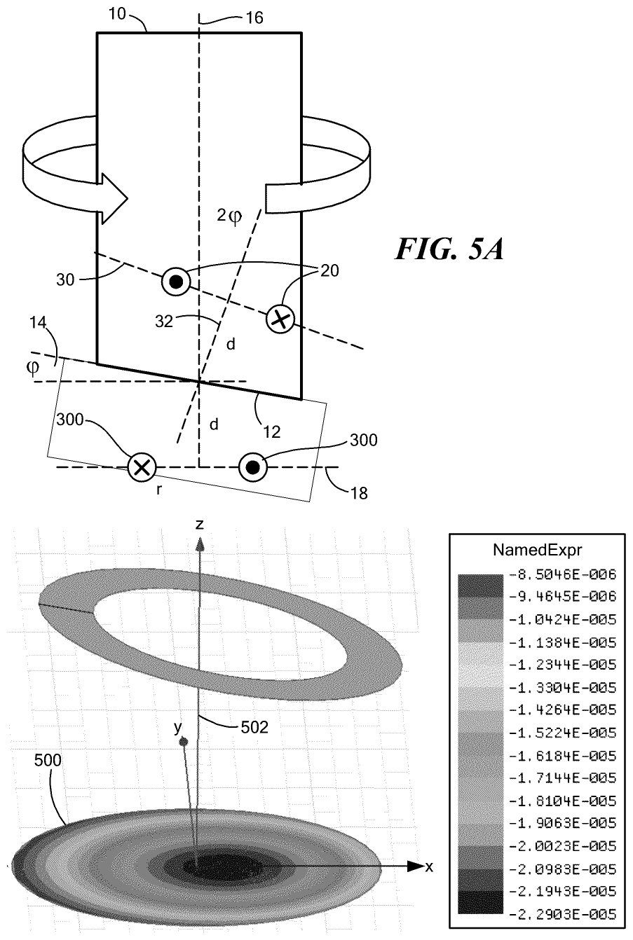

FIG. 5 shows a rotating target 10 subjected to a field from the main coil 300 generating a reflected signal 500 shown below the target. As can be seen, in the plane 18 of the main coil 300 the reflected signal from the mirror coil model is not symmetric. The asymmetric signal rotates about a rotation axis 502, which can correspond the target longitudinal axis 16, as the target 10 rotates. This asymmetric signal rotation can be detected by pickup coils. FIG. 5A shows the target rotated about 180 degrees and corresponding field.

The reflected signal 500 is generated from an example modelled system in which d=1 mm, θ=5°, r=1.5 mm (radius of main coil) where the main coil has outer radius of 1.5 mm and an inner radius of 1.05 mm. The current to the main coil 300 is 300 mA-turns. It is understood that only the mirrored coil is modelled in the illustrated embodiment. In embodiments, the main coil 300 field is substantially cancelled by differential pick up coils.

The reflected field is plotted as B in the z-direction, which is what the pick up coils detect. As can be seen, the strongest field level is off center towards the closer piece of the cylinder 10. The reflected field rotates with the cylinder/target 10. With an offset reflected field, pick up coils centered on the main coil 300 will detect the off-center field.

It is understood that various types and arrangements of pick up coils can be used to meet the needs of a particular application. Coils can be circular, ovular, square, polygonal, and the like, and can have any practical width and thickness.

It is understood that the mutual inductance between the main and pickup coils changes as the target rotates. The mutual inductance is proportional to the sum of the fields directly produced by the main coil and reflected from the target, which the pick-up coils encompass. It is desirable to have low mutual inductance between the main coil and the pickup coils due to the direct field to enable sensing of the reflected field in the presence of the field generated by the main coil. Mutual inductance due to the direct field creates an offset that is constant over angle (theta), which can be large due to the close proximity of the coils, making it challenging to detect the small change in mutual inductance due to the reflected field changing over angle (theta). Where each of the pick-up coils encompass a total of near zero field from the main coil (note that encompassing field clockwise adds to the total and counterclockwise subtracts from the total), the mutual inductance due to the direct field will approach zero. That is, the pick-up coils are configured such that the net field from the main coil on the pick-up coils is substantially zero.

In embodiments, first and second sets of differential pick up coils detect the field from the mirrored coil. Differential coils may cancel out the direct field from the main coil. In one embodiment, first and second sets of coils are 90 degrees out of phase to yield sine and cosine outputs on which an arctangent can be used. Using sine and cosine signals may enhance immunity to system variations, e.g., airgap, temperature, frequency etc., as well as stray field immunity. In addition, DC fields will not be picked up by the coils, while uniform AC fields may be rejected by the differential coils.

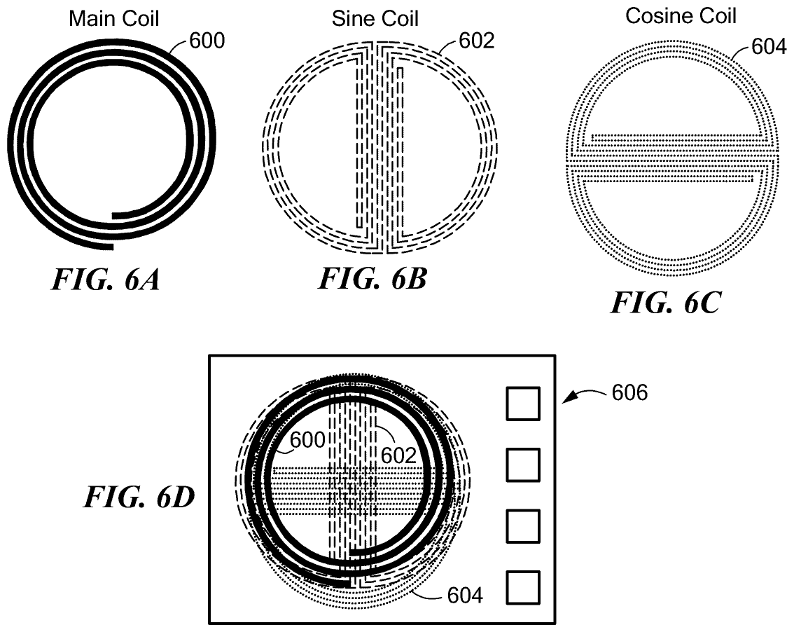

FIG. 6A shows an example configuration for a main coil 600, FIG. 6B shows an example configuration for a sine coil 602, and FIG. 6C shows an example configuration for a cosine coil 604. FIG. 6D shows an example embodiment of a stacked arrangement 606 in which the main coil 600, cosine coil 604, and sine coil 602 overlap each other, wherein each coil has about the same radius. An example angle sensor having transit and receive coils is shown in U.S. Pat. No. 11,112,230, which is incorporated herein by reference.

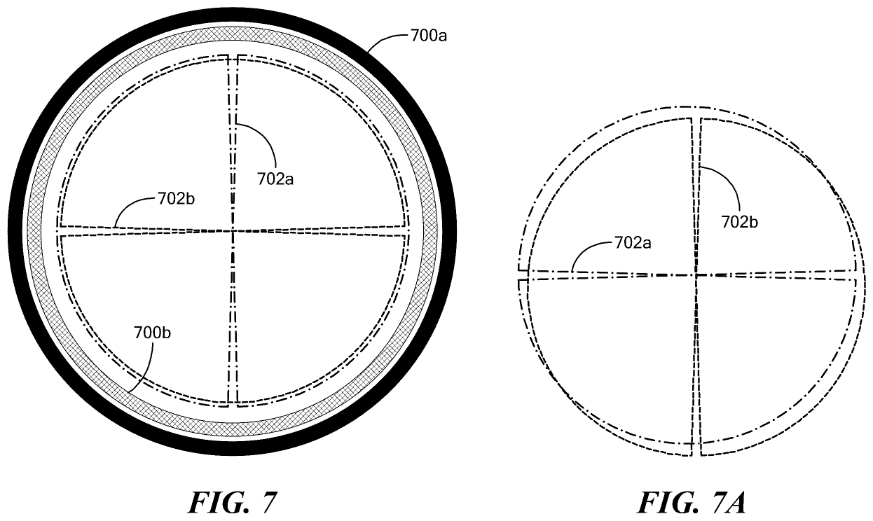

FIG. 7 shows example transmit coils 700a,b and receive coils 702a,b. FIG. 7A shows the receive coils 702a,b offset from each other slightly in order that may be seen separately. As can be seen, in an example embodiment, the receive coils 702a,b are formed from a circular shape with a twist along the diameter to form a shape that can be referred as a butterfly coil. The direction of the twist is used to obtain a sine signal and a cosine signal by enforcing perpendicularity between the respective twists.

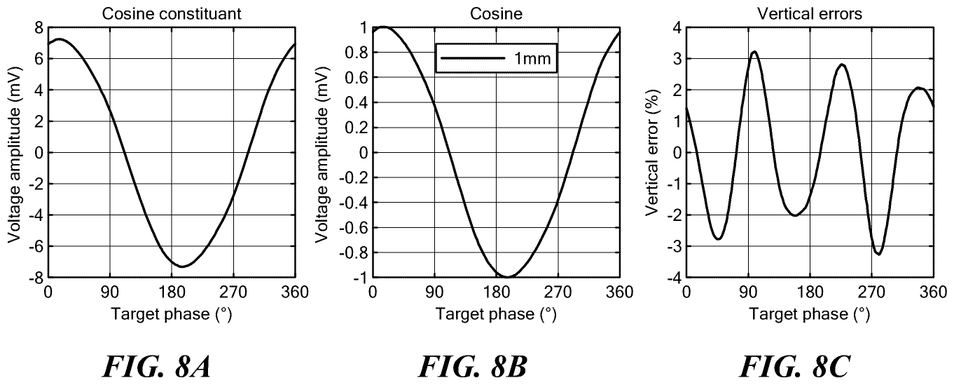

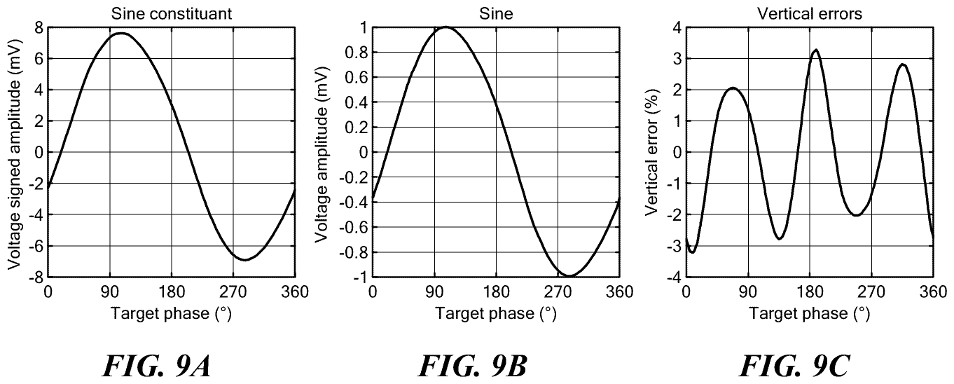

FIG. 8A shows a cosine signal from the receive coils 702b, FIG. 8B shows a normalized cosine signal, and FIG. 8C shows vertical error versus target phase. Similarly, FIG. 9A shows a sine signal from the receive coils 702a, FIG. 9B shows a normalized sine signal, and FIG. 9C shows vertical error versus target phase. FIGS. 8A and 9A represent the output voltage of the sine and cosine coils (for a drive current of 100 mA, a drive frequency of 3.5 MHz and a 1 mm air gap). The vertical error is defined as follows: if the signal has an amplitude A, a phase P and an offset O, the vertical error is defined as:

$${Err}_{Vertical} = \frac{Signal - [ A cos ( θ - P ) + O ]}{A}$$

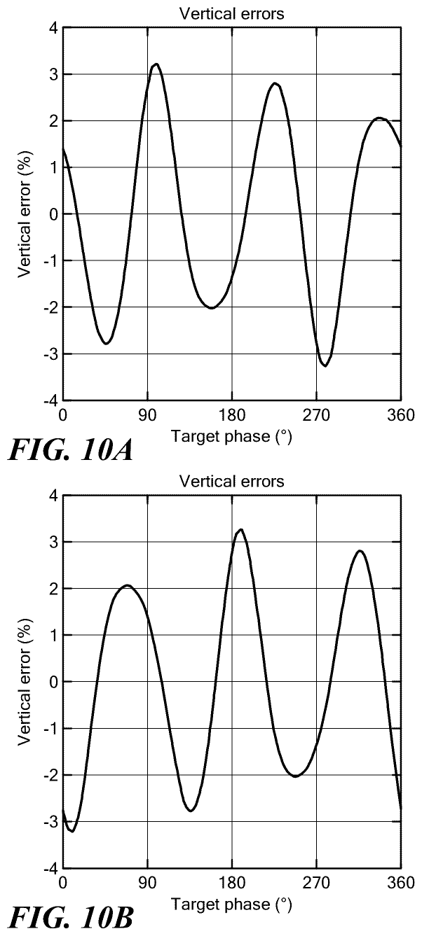

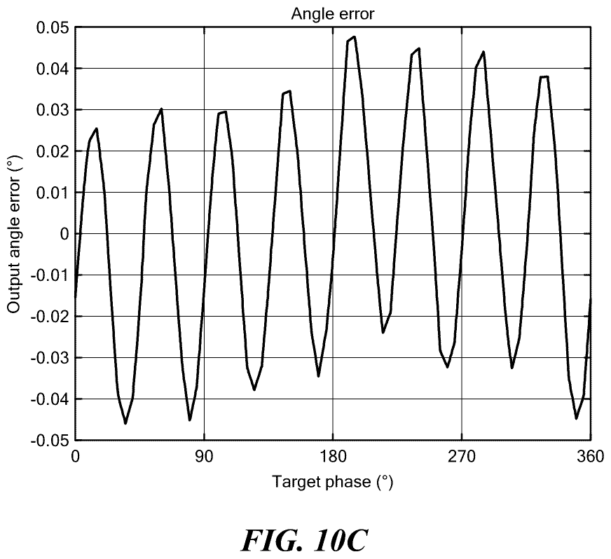

FIG. 10A shows vertical error for cosine, FIG. 10B shows vertical error for sine, and FIG. 10C shows output angle error for the coil configuration of FIG. 7.

However, if one wants to reduce the angle error at the transducer level, the main source of errors in the signal paths can be characterized in a way other than the output angle error. As can be seen, this error is an interference pattern of the vertical errors of both channels, as shown in FIG. 10C. The vertical error is third harmonic on sine and cosine, but the fourth harmonic on the angle error. Because the residual vertical error is due to third order harmonic effects, the vertical error can be reduced by adding a second constituent coil tilted/offset by 60° (180°/3) from the first coil.

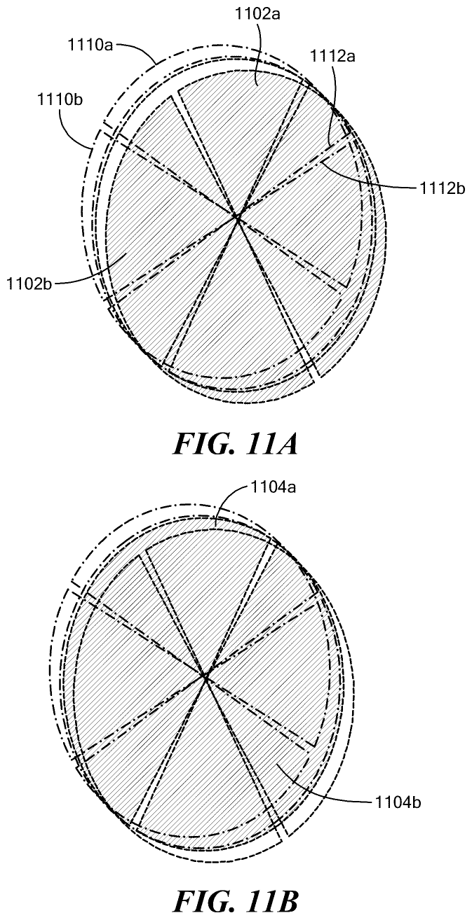

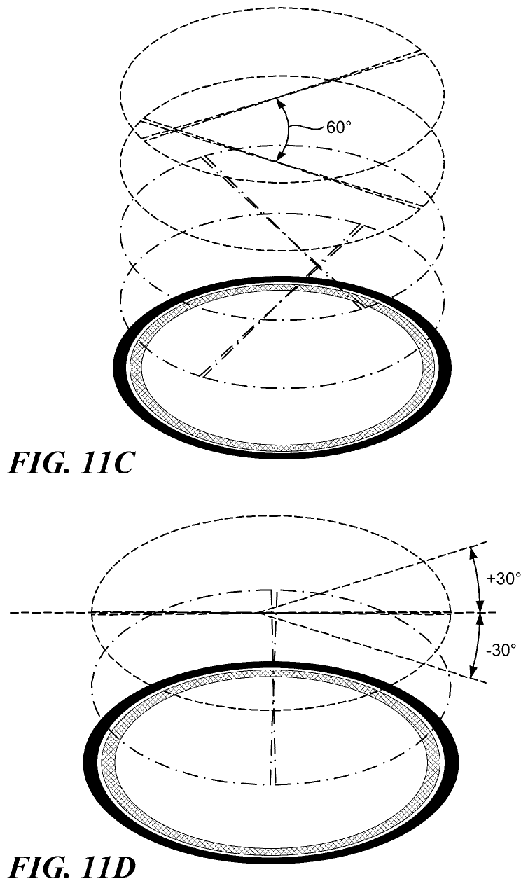

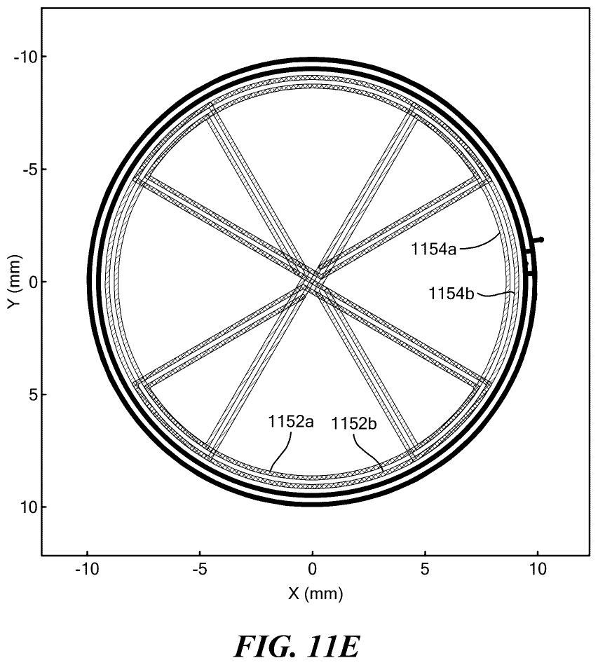

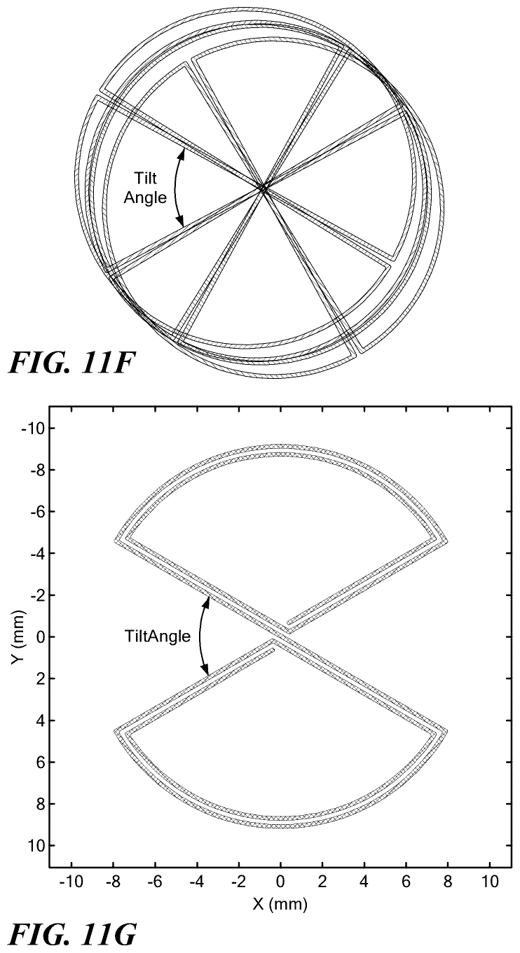

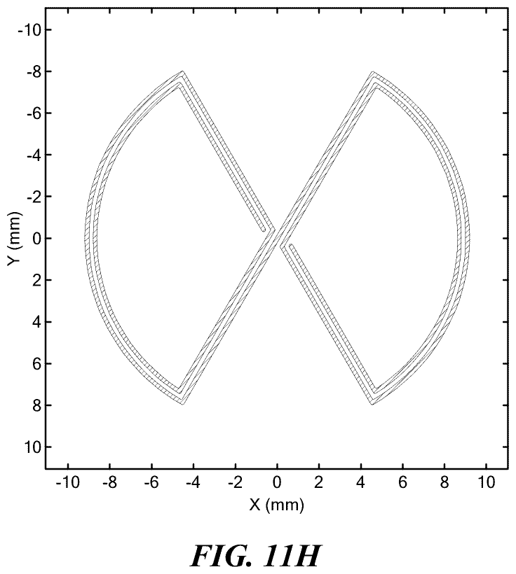

FIGS. 11A-D show a receive coil configured to compensate for third order harmonic vertical error in the sine and cosine channels of the transducer. In the illustrated embodiment, each of first and second signal paths comprises first and second butterfly coils-one coil is tilted at minus 30° from the original single coil configuration and the other coil tilted plus 30° for total of 60 degree offset/tilt (see FIGS. 11C and 11D). It is understood that the paired butterfly coils are connected in series.

As best seen in FIG. 11A, in the illustrated embodiment, a first signal path, which may correspond to cosine, includes a first butterfly coil 1102 having first and second “wings 1102a,b and a second butterfly coil 1104 having third and fourth “wings” 1104a,b, as best seen in FIG. 11B. It is understood that the hatching is intended to more easily identify the butterfly coils and is not intended to limit the scope of the claims in any way. FIG. 11C shows the butterfly coils in an exploded view with the transmit coil at the bottom.

A second signal path, which can correspond to sine, can include a first butterfly coil 1110 with wings 1110a,b offset from a second butterfly coil 1112 with wings 1112a,b for third order harmonic compensation.

In some embodiments, the butterfly coils can stand on respective printed circuit board (PCB) layer. FIG. 11E shows the coils of FIG. 11B simplified. The first and second wings 1102a,b of FIG. 11A correspond to wings 1152a,b in FIG. 11E and the third and fourth wings 1104a,b correspond to wings 1154a,b. FIG. 11F shows an example tilt angle indicated and FIGS. 11G and 11H shows the respective butterfly coils separately. In this coil configuration, the tilt angle is the same.

The first and second butterfly coils 1102a,b of FIG. 11A are equivalent to the coils in FIG. 11H. The first and second butterfly coils 1110a,b of FIG. 11A are equivalent to the coils in FIG. 11G. It is understood that there are two turns in the coils shown in FIGS. 11H and 11G because they are made from two butterfly coils.

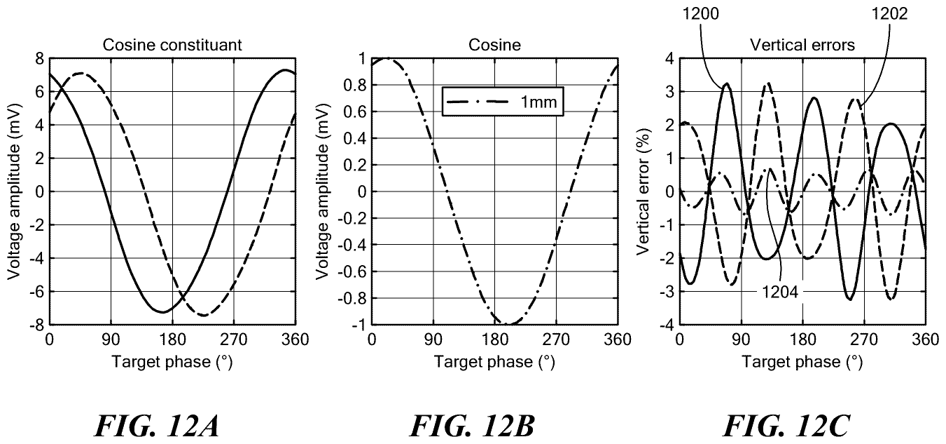

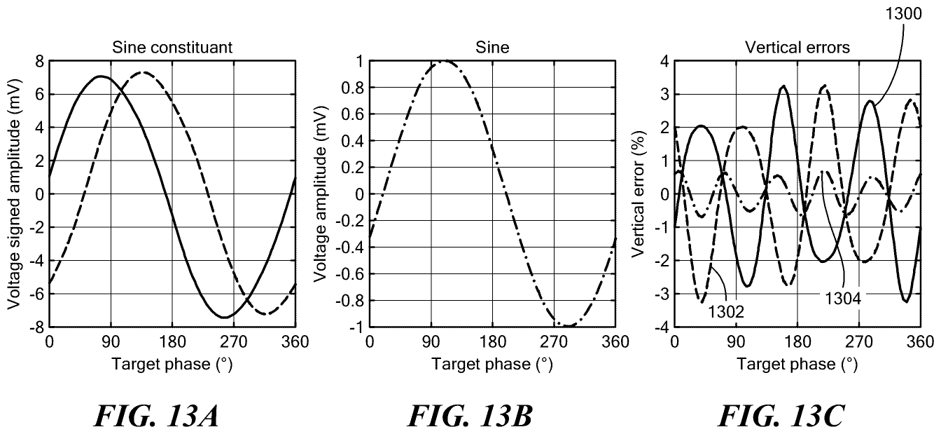

FIGS. 12A-12C and 13A-12C show respective cosine (from coils 1110a,b and 1112a,b) and sine (from coils 1102a,b and 1104a,b) constituent signals, normalized cosine and sine signals, and cosine and sine vertical error in percentage of each signal's amplitude. FIGS. 12A and 13A show the signal of the constituent coils (individual loops) of the sine and cosine signals. FIGS. 12B and 13B show the sum of the constituent coils normalized. FIGS. 12C and 13C show the vertical errors for the constituent coils 1200, 1202, 1300, 1302 and for the full sine and cosine signals 1204, 1304. Each constituent coil has a vertical error of about 3.2% due mainly to third harmonic effects. As can be seen, the vertical error is reduced from 3.2% to 0.7% with third order harmonic compensation. It is understood that a significant component of the 0.7% error may be due to fifth harmonics.

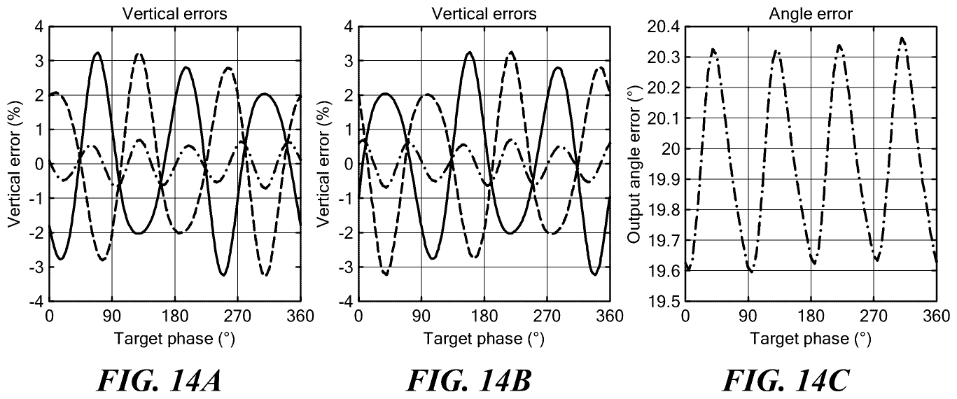

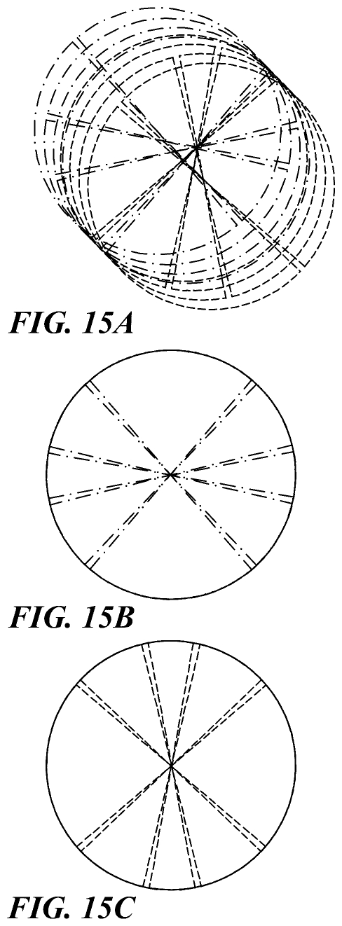

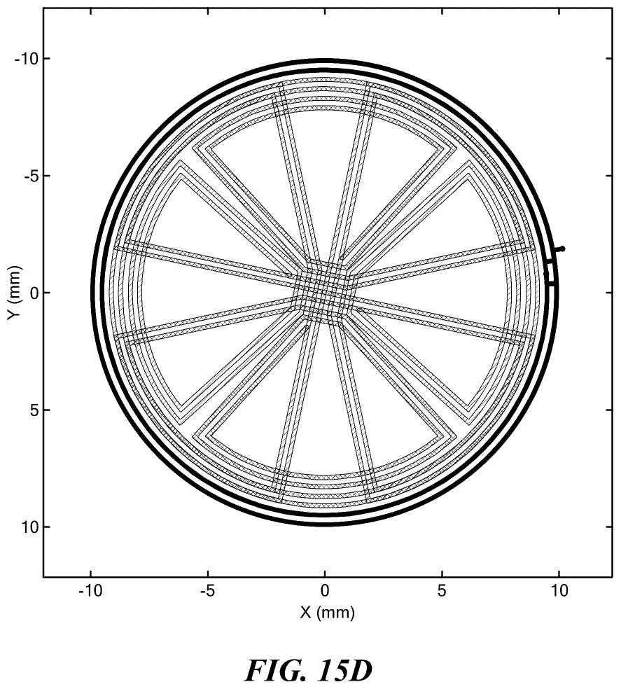

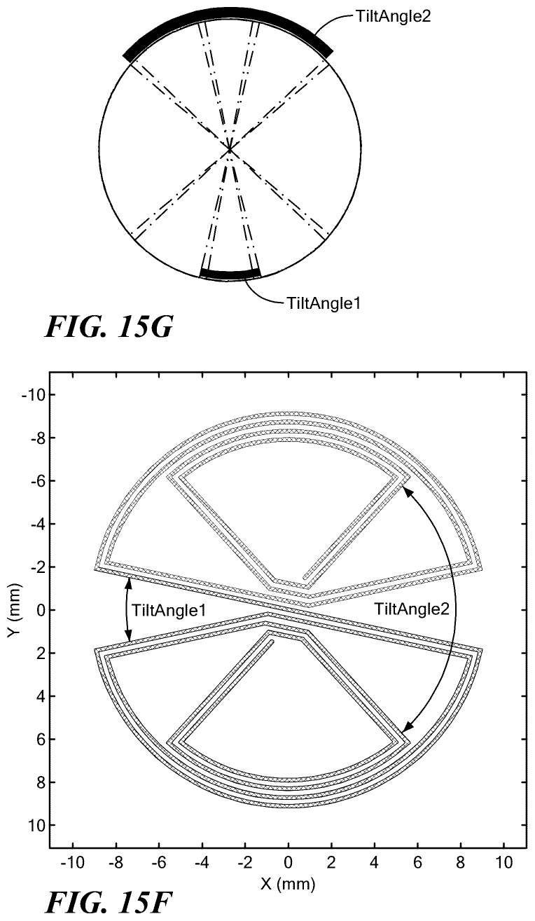

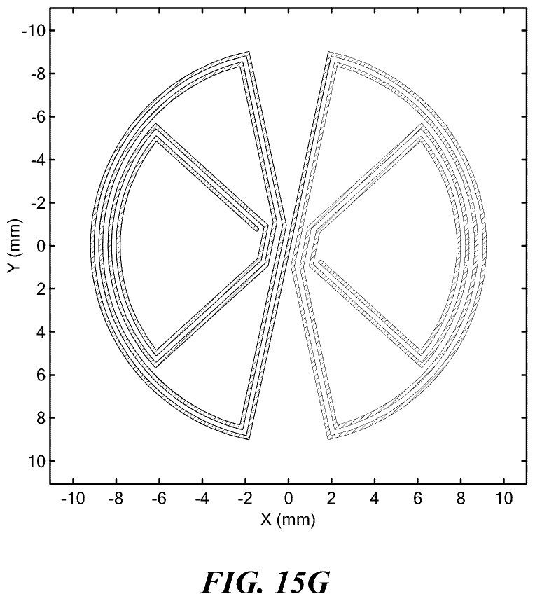

FIG. 14A shows cosine vertical error, FIG. 14B shows sine vertical error, and FIG. 14C shows the corresponding angle error decrease from 1.7° down to 0.4° angle error. Because the residual vertical error is fifth harmonics after third order harmonic compensation, one can compensate for the fifth harmonics with additional coils, such as by duplicating the two constituent coils by 36° (180°/5), as shown in FIG. 15A. FIG. 15B is intended to more easily enable cosine butterfly coils to be seen and FIG. 15C is intended to more easily enable sine butterfly coils to be seen. FIG. 15D shows a PCB layer coil implementation similar to that shown in FIG. 11E. Each signal path is made of four pairs of butterfly coils (the tilt is ±12°; ±48°). Example angle configurations are set forth below:

$$48 = 60 / 2 + 36 / 2$$

$$12 = 60 / 2 - 36 / 2$$

$$- 12 = - 60 / 2 + 36 / 2$$

$$- 48 = - 60 / 2 - 36 / 2$$

In the illustrated embodiment, angle calculation to compensate for harmonics {n1, n2, n3 . . . } can be represented as angles the sum over i of ±90°/n_i.

FIG. 15E shows a coil configuration having first and second tilt angles and FIGS. 15F and 15G show the coils and tilt angle separately for a single PCB layer embodiment. This type of coil configuration yields the same benefits as basic butterfly coil configurations but only requires two layers per alternative coil whatever the number of harmonics to be compensated. Basic butterfly coil set requires 2\hat{ }(number of harmonics). In layer coil configurations, most of the coil is on a single layer and the closure of the coil passes through a second layer.

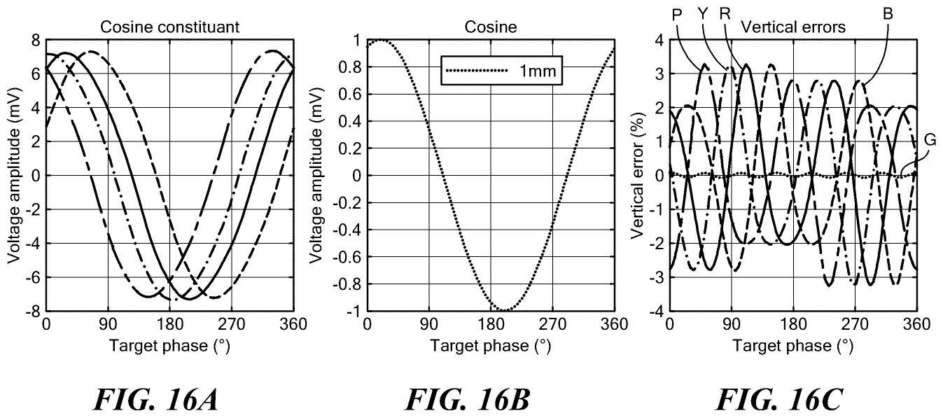

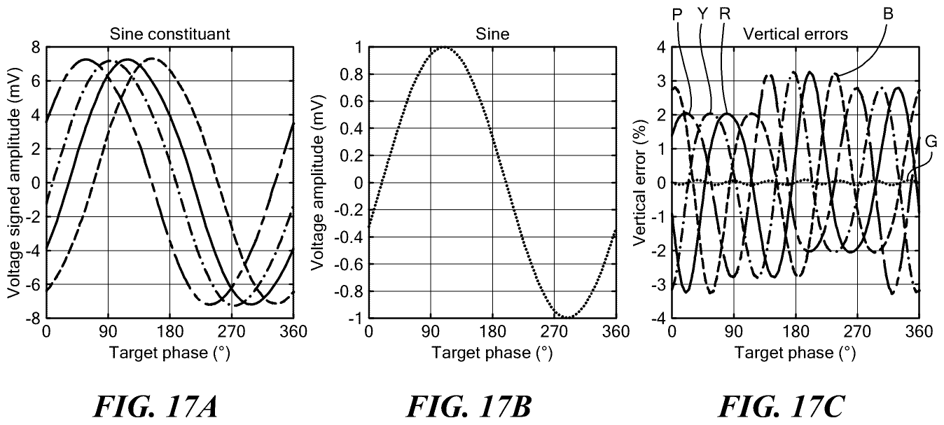

FIGS. 16A and 17A show plots for the signal from each constituent coils of the respective sine and cosine signal paths. FIGS. 16B and 17B shows plots for the normalized sum of all constituents of each signal path. FIGS. 16C and 17C represent the corresponding vertical error B, R, Y, P for the constituent coil signals and G for the full sine and cosine signals). The vertical error drops from 0.7% (with 3^{rd} harmonics correction) down to 0.04% with third and fifth harmonics correction.

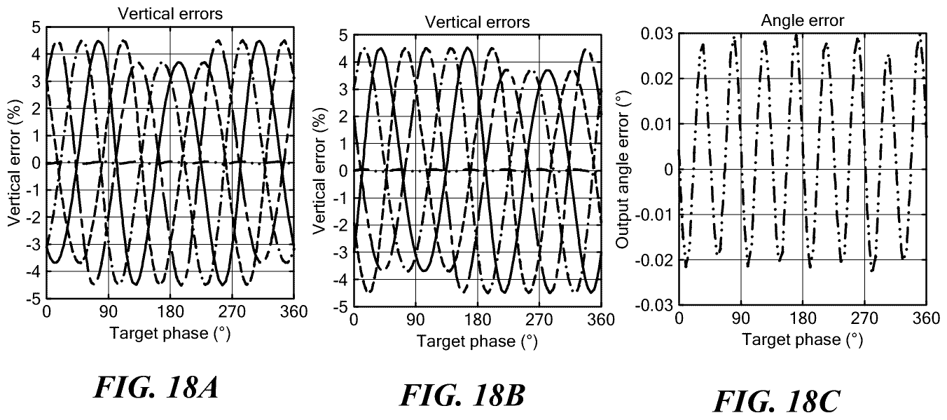

FIGS. 18A and 18B show vertical errors for respective sign and cosine channels for four coils per channel. FIG. 18C shows corresponding angle error drops from 0.4° (with third harmonics correction) down to 0.03° with both third and fifth harmonics. The residual vertical error is now seventh harmonics. In embodiments, error can be further reduced by cloning constituent coils and tilting them by 25.7° (180°/7).

Table 1 below shows various tilts, vertical errors and angle errors for the different configurations of harmonics correction.

TABLE 1

| Harmonic | | | Third & |
|---|---|---|---|
| compensation | None | Third | fifth |
| Tilt angles | 0° | ±30° | ±12°; ±48° |
| Vertical error | ±3.2% | ±0.7% | ±0.04% |
| Angle error dynamics | ±1.7° | ±0.4% | ±0.03° |

Embodiments of the disclosure allow increased angle accuracy, e.g., 57× better, with third and fifth harmonics correction at the transducer level without changes to front end processing. In addition, example transducer embodiments provide increased accuracy without an increase in PCB real estate.

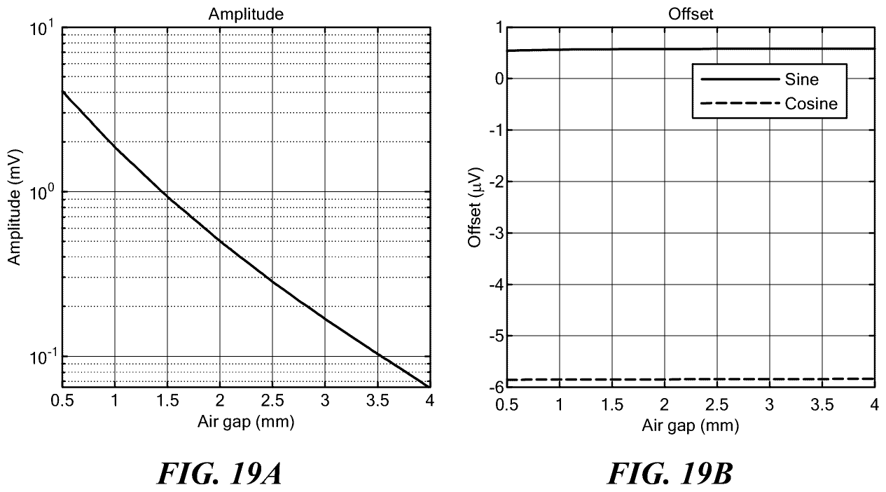

FIG. 19A shows amplitude in mV versus airgap distance in mm and FIG. 19B shows offset in u V versus airgap in mm for sine and cosine signals which demonstrate that offset is very low (in comparison with amplitude) and constant over air gap so that it can be calibrated out once and for all at the very beginning.

As described above, in example embodiments, a magnetic field angle sensor includes heterogeneous redundant sensing in the form of magnetic and inductive field sensing to provide redundant angle sensing. A sensor IC package can be positioned in relation to a target and/or coils. The target can include a magnetic portion and a metallic portion and a printed circuit board (PCB) can include inductive coils. Magnetic angle sensing can be achieved with sensing elements that can include, for example, one or more of MR, e.g., TMR elements, planar Hall elements, vertical Hall elements, barycenter magnetic sensor, and/or fluxgates, etc., and inductive sensing with transmit and receive coils.

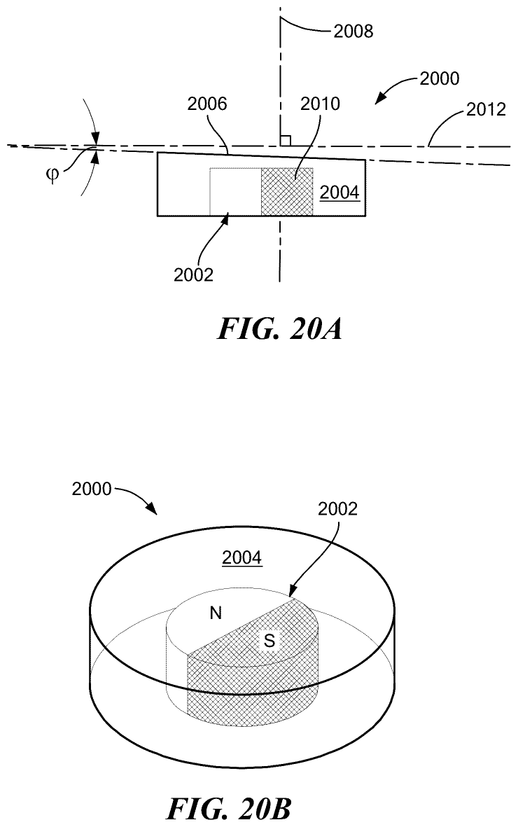

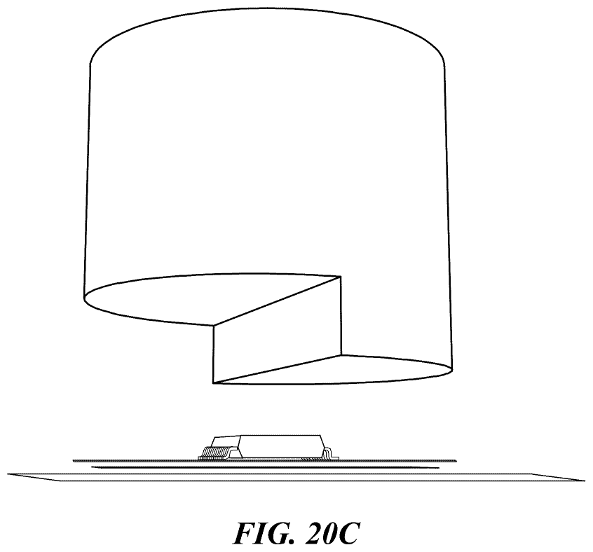

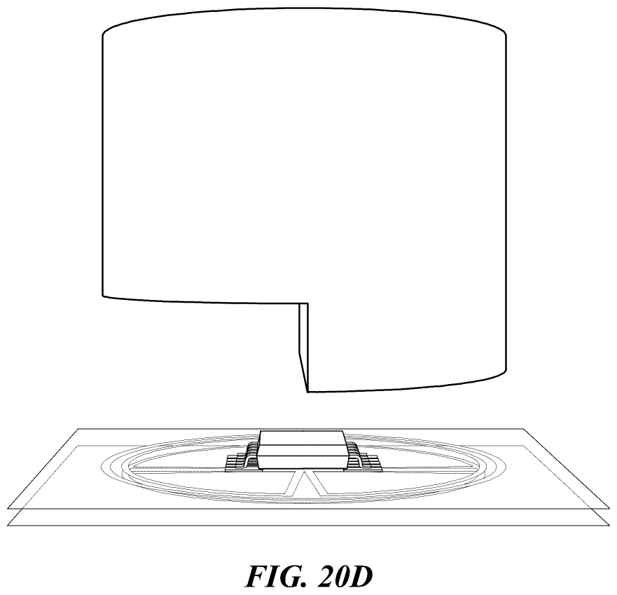

FIG. 20A is a cross-sectional view and FIG. 20B is a partially transparent isometric view of an example target 2000 having a cylindrical puck magnet 2002 and a cap 2004. In embodiments, the cap 2004 comprises a nonmagnetic, conductive, metal, such as copper or aluminum. The example magnet 2002 is shown having single north N and south S poles, however, any suitable number of poles can be used. In embodiments, the cap 2004 has a coil-facing surface 2006 with a slant cut angle φ that ranges from 1° to 10°. In the illustrated embodiment, the slanted surface 2006 is linear and the angle φ is defined by a first axis 2008 perpendicular to a coil-facing slanted surface 2010 of the magnet 2002, a second axis 2012 perpendicular to the first axis, and the linear slanted surface 2006.

It is understood that the surfaces 2006, 2010 of the magnet 2002 and the cap 2004 can be slightly irregular, rough, undulating, arcuate, etc., without departing from the scope of invention as claimed.

It will be appreciated by one of ordinary skill in the art that the slant of the cap 2004 may not require much precision since the sensor may be insensitive to this type of misalignment, which may reduce manufacturing costs. In addition, cutting a slant in the cap may be significantly less costly than cutting a half moon cap, such as the cap shown in FIGS. 20C and 20D.

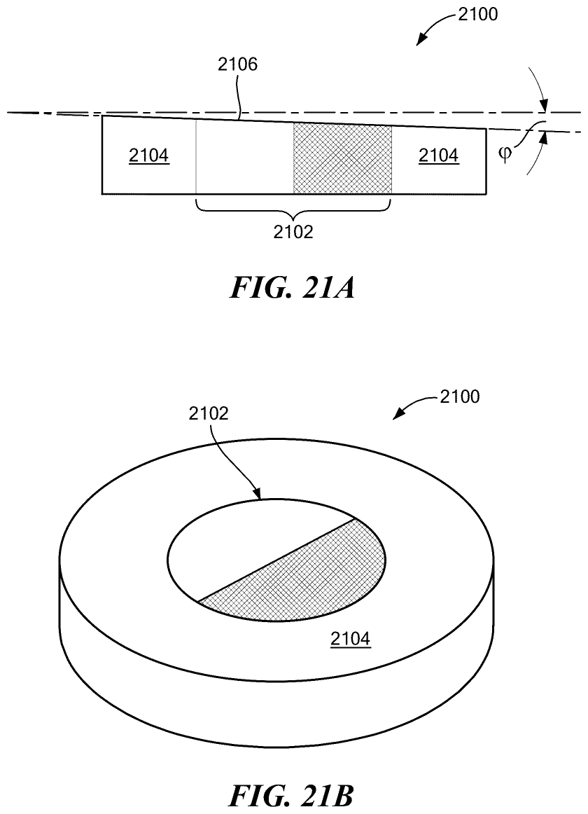

FIG. 21A is a cross-sectional view and FIG. 21B is a partially transparent isometric view of an example target 2100 having a cylindrical puck magnet 2102 and a cap 2104 where the magnet and cap combine to form a slant surface 2106 having a slant angle q. The slant surface 2106 is configured to face coils and sensing elements. In the illustrated embodiment, the top surface 2106 of the magnet 2102 is exposed. In embodiments, the cap 2104 may comprise a ferromagnetic material.

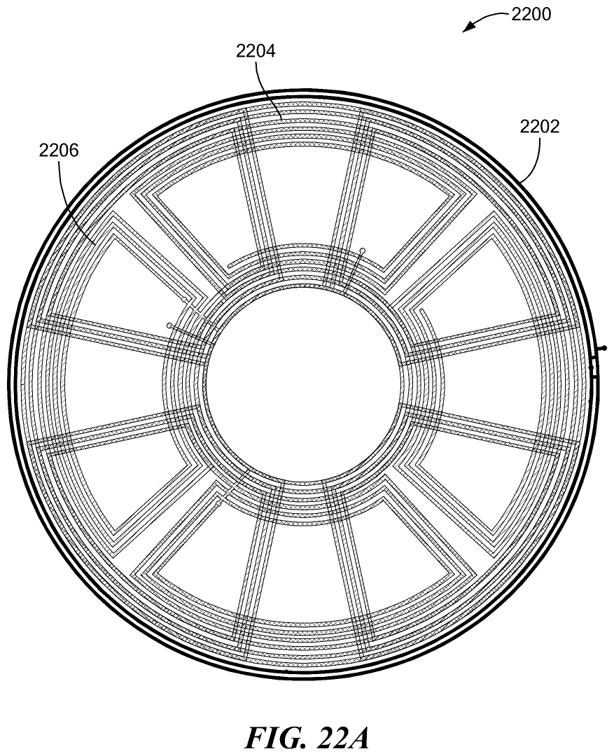

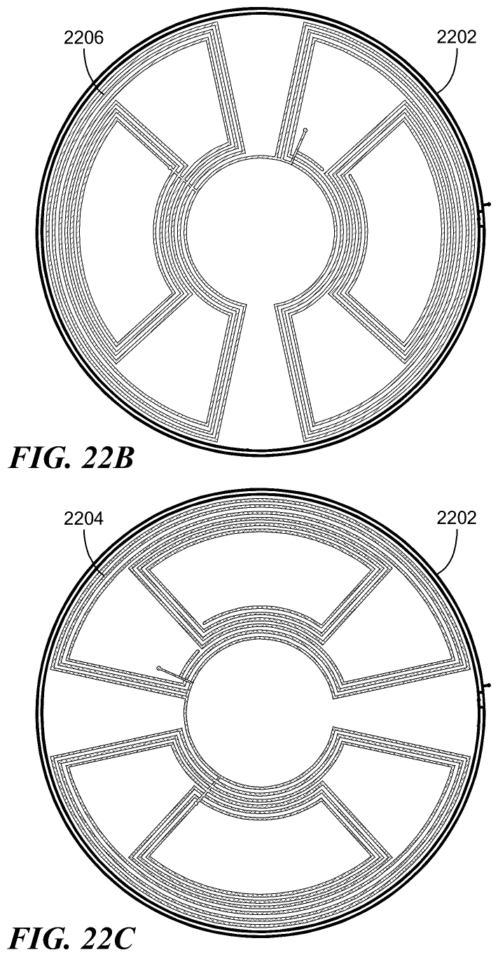

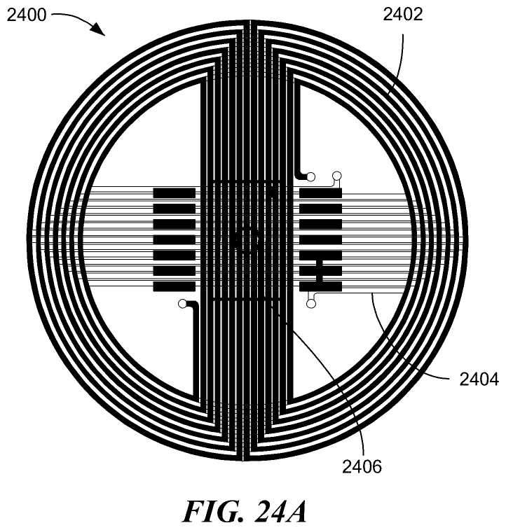

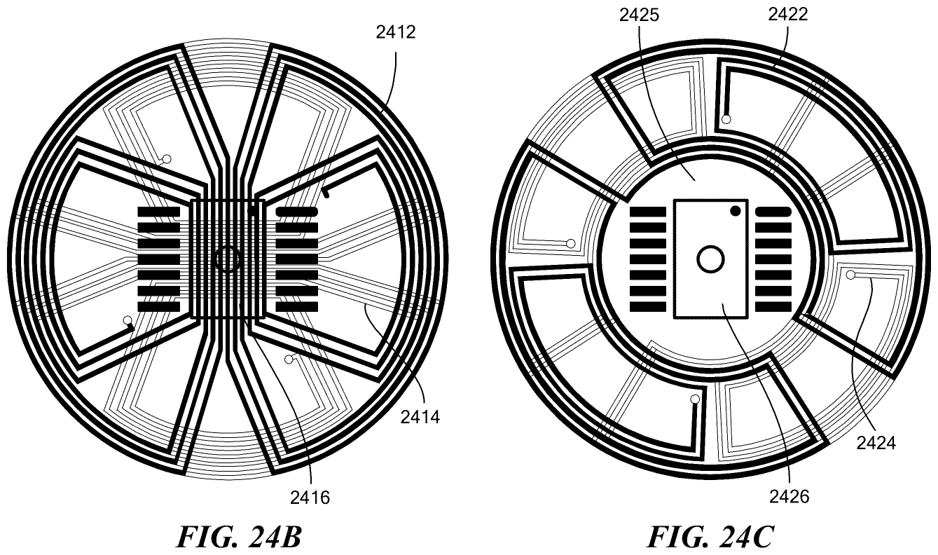

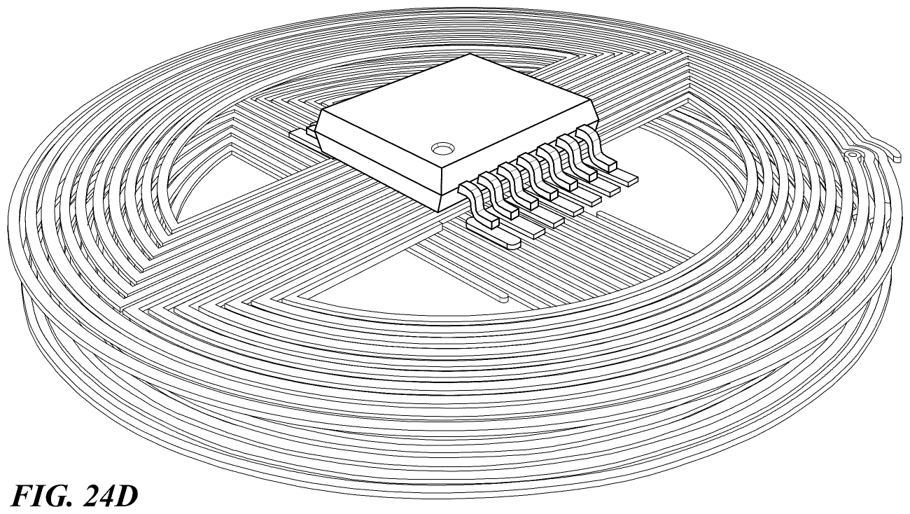

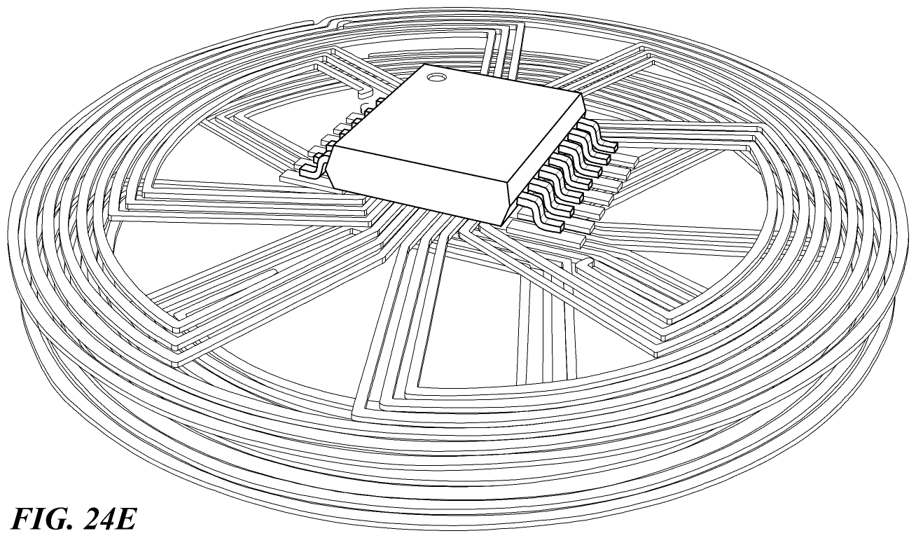

FIG. 22A shows an example inductive sensing coil configuration 2200 having a transmit coil 2202 and first and second receive coils 2204, 2206, FIG. 22B, shows only the first coil layer including receive coil 2206 and the first part of the transmit coil 2202a and FIG. 22C shows only the second coil layer including receive coil 2204 and the second part of the transmit coil 2202b. The illustrated coils are similar to the butterfly coils shown and described above. The illustrated coil configuration 2200 is well suited for full stroke inductive angle sensing, e.g., there is a single period in the system (one period per rotation), which is similar to FIG. 24B. For example, the linear portions of the signal shown in FIG. 16B can be used as a linear approximation of the target angle for short stroke movement of the target.

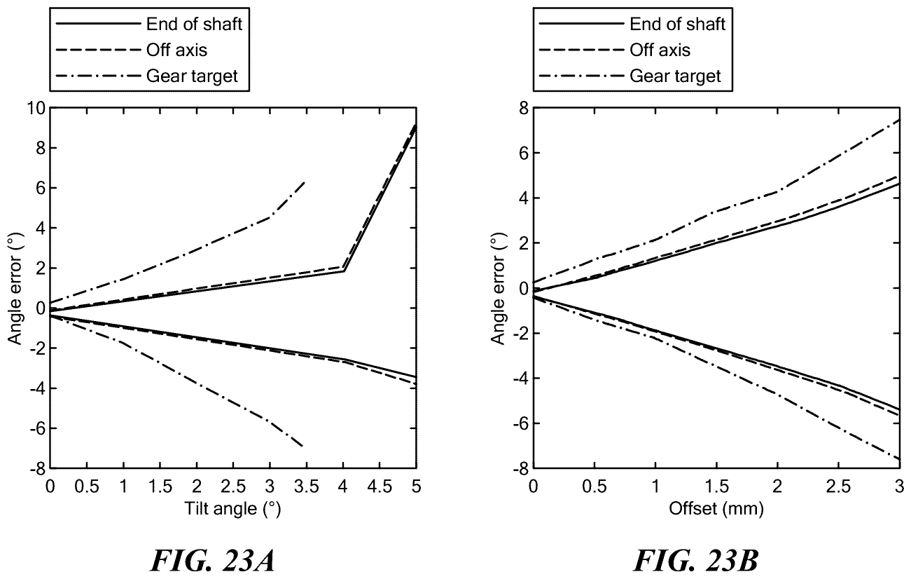

FIG. 23A shows inductive sensor angle error over PCB tilt and FIG. 23B shows misplacement for the example sensor and coil configuration of FIG. 24C below. The off axis curve is the error for this concept considering the presence of the magnetic angle sensor in the center of the PCB. The end of shaft curve is the angle error that can be achieved without the magnetic target and angle sensor. The gear target curve is the angle error achieved with a half-moon target inductive angle sensor. It is understood that off axis means that the part of the target that is right in line with the rotating axis is not used, e.g., the set of coils in FIG. 24C. End of shaft is what is shown in FIGS. 24A and 24B.

FIG. 24A shows an example sensing system 2400 having a butterfly coil configuration with a first (top) coil 2402 and a second (bottom) coil 2404 and a sensor IC package 2406 placed at the center of the coils. In the illustrated embodiment, the coils 2402, 2404 are under the IC 2406 and no harmonic compensation is performed. The number of turns of the receive coils is limited by the room under the sensor 2406. In embodiments, one of the receive coils 2402, 2404 is located on a second layer of a printed circuit board (PCB) to enable room for external connection of the coil.

FIG. 24B shows a butterfly coil configuration, such as that shown and described above, with harmonic compensation. In the illustrated embodiment, the configuration of the first and second coils 2412, 2414 corrects for 3rd and 5th harmonic components. The first and second receive coils 2412, 2414 are adjusted by routing of the first (top) receive coil under the sensor package. The second (bottom) receive coil is also adjusted in a similar way to keep both signals consistent. FIG. 24E shows an example layer configuration.

FIG. 24C shows first and second butterfly coils 2422, 2424 configured to provide a coil-free region 2425 in which an IC 2426 can be placed. In embodiments, the coil-free region 2425 is located in a center of the coils 2422, 2424. The coil-free region 2425 has minimal impact on the inductive sensor output and is mainly amplitude reduction.

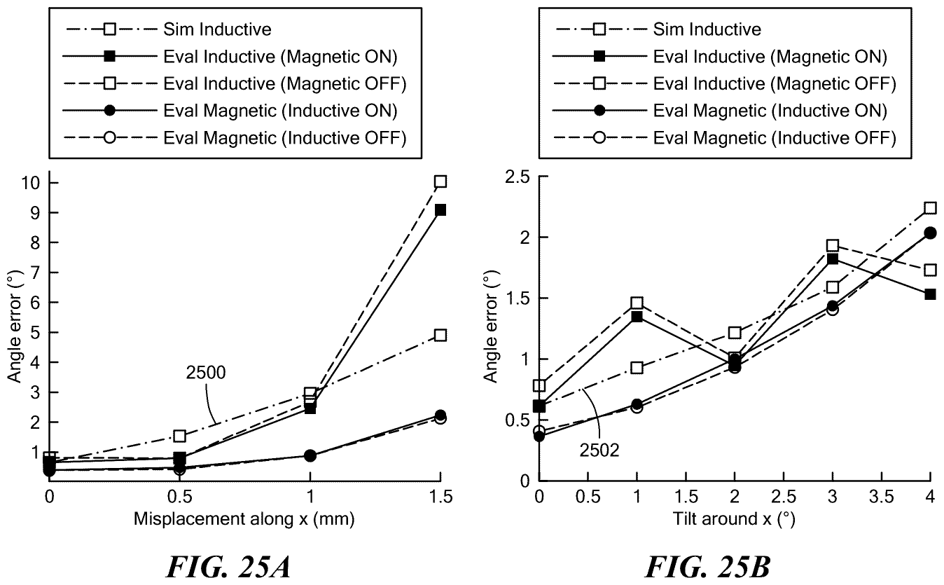

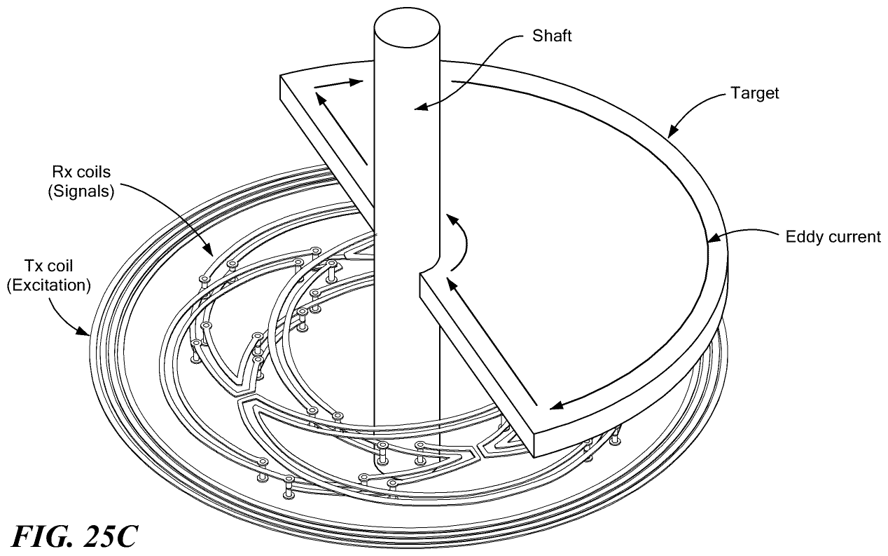

FIGS. 25A and 25B are graphical representations of angle error over misplacement (FIG. 25A) and tilt (FIG. 25B) of the sensor shown in FIG. 24A. Solid lines indicate when both magnetic and inductive sensing are active and dashed lines indicate when only one of the two sensing systems is on. The narrow lines 2500, 2502 in the respective figures is the simulated angle error for the inductive sensor of FIG. 24C.

As can be seen, there is little difference in angle error when both magnetic and inductive are on (solid lines) and when only one of them is on (dashed lines). The impact of the magnetic IC die on the inductive system is limited by the coil layout and the position of the magnetic IC die in the center while, the impact of the inductive sensor on the magnetic sensor is limited by the frequency chosen higher than the bandwidth of the magnetic sensor.

In some embodiments, a first die is used for the magnetic sensing components and a second die is used for inductive sensing components. In embodiments, a single IC package includes the first and second die. In some embodiments, processing of the magnetic and inductive signals is performed by a processor in the single IC package. In other embodiments, at least some of the signal processing or redundancy processing is performed remotely, such as on a separate IC package. In embodiments, the signals from the inductive system and the signals from the magnetic sensing system provide redundancy so that target position data is available even if one of the inductive or magnetic system is not operational.

Table 1 below outlines differences between slant target and half-moon target systems. FIG. 25C shows an example half moon target system. Note that the half moon target may be detected by sinusoidal coils. Table 1 provides comparison between existing coil design (sinusoidal) and butterfly coils.

TABLE 1

| | Slant target | Half moon |
|---|---|---|
| Magnet target size | Not limited | Limited by inner |
| | by inductive | diameter of |
| | system | Rx coils |
| Accuracy in ideal position | <0.8° | <0.8° |
| Accuracy over misplacement | High up to 1 mm | High up to 1 mm |
| Accuracy over sensor tilt | High | Low |
| Start up error | High | Low |
| Calibration | Required | Not needed |

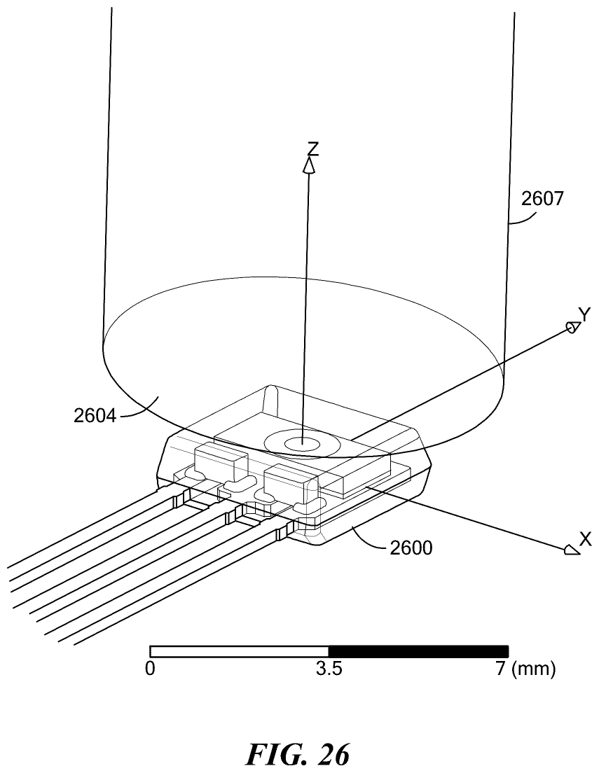

FIG. 26 shows an example embodiment of an angular position sensor IC package 2600 with a target 2602 at a given air gap. The target 2602 is shown as a cylinder having a cut end 2604. The sensor 2600 has a give die size that allows for a 1.5 mm diameter coil in the example embodiment. A 1.3 mm from die-face to target center results in the order of a 1 mm airgap from package face of the IC package 2600 to lowest portion of the target 2602, e.g., a N 8 mm diameter rod.

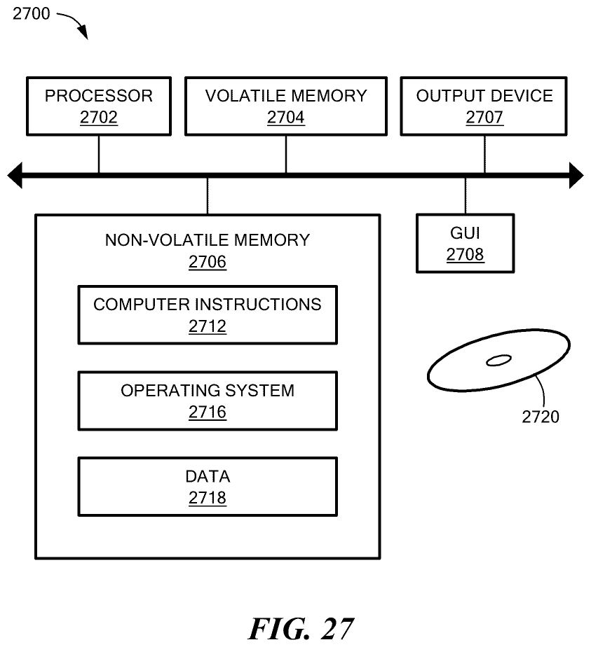

FIG. 27 shows an exemplary computer 2700 that can perform at least part of the processing described herein. The computer 2700 includes a processor 2702, a volatile memory 2704, a non-volatile memory 2706 (e.g., hard disk), an output device 2707 and a graphical user interface (GUI) 2708 (e.g., a mouse, a keyboard, a display, for example). The non-volatile memory 2706 stores computer instructions 2712, an operating system 2716 and data 2718. In one example, the computer instructions 2712 are executed by the processor 2702 out of volatile memory 2704. In one embodiment, an article 2720 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

As used herein, the term “magnetic field sensor” is used to describe a circuit that uses a magnetic field sensing element, generally in combination with other circuits. Magnetic field sensors are used in a variety of applications, including, but not limited to, an angle sensor that senses an angle of a direction of a magnetic field, a current sensor that senses a magnetic field generated by a current carried by a current-carrying conductor, a magnetic switch that senses the proximity of a ferromagnetic object, a rotation detector that senses passing ferromagnetic articles, for example, magnetic domains of a ring magnet or a ferromagnetic target (e.g., gear teeth) where the magnetic field sensor is used in combination with a back-biased or other magnet, and a magnetic field sensor that senses a magnetic field density of a magnetic field.

As used herein, the term “magnetic field sensing element” is used to describe a variety of electronic elements that can sense a magnetic field. The magnetic field sensing element can be, but is not limited to, a Hall effect element, a magnetoresistance element, or a magnetotransistor. As is known, there are different types of Hall effect elements, for example, a planar Hall element, and a vertical Hall element. As is also known, there are different types of magnetoresistance elements, for example, a semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

As is known, some of the above-described magnetic field sensing elements tend to have an axis of maximum sensitivity parallel to a substrate that supports the magnetic field sensing element, and others of the above-described magnetic field sensing elements tend to have an axis of maximum sensitivity perpendicular to a substrate that supports the magnetic field sensing element. In particular, planar Hall elements tend to have axes of sensitivity perpendicular to a substrate, while metal based or metallic magnetoresistance elements (e.g., GMR, TMR, AMR) and vertical Hall elements tend to have axes of sensitivity parallel to a substrate.

As used herein, the term “magnetic field sensor” is used to describe an assembly that uses one or more magnetic field sensing elements in combination with an electronic circuit, all disposed upon a common substrate, e.g., a semiconductor substrate. Magnetic field sensors are used in a variety of applications, including, but not limited to, angle sensors that sense an angle of a direction of a magnetic field, angle sensors that sense an angle of rotation of a target object, and rotation sensors that sense rotation of a rotating target object (e.g., speed and direction of rotation).

Magnetic field sensors in the form of angle and/or rotation sensors that can sense an angle of rotation of a ferromagnetic object are described herein. As used herein, the term “magnetic field signal” is used to describe any circuit signal that results from a magnetic field experienced by a magnetic field sensing element.

The terms “parallel” and “perpendicular” are used in various contexts herein. It should be understood that the terms parallel and perpendicular do not require exact perpendicularity or exact parallelism, but instead it is intended that normal manufacturing tolerances apply, which tolerances depend upon the context in which the terms are used. In some instances, the term “substantially” is used to modify the terms “parallel” or “perpendicular.” In general, use of the term “substantially” reflects angles that are beyond manufacturing tolerances, for example, within +/− ten degrees.

As used herein, the term “processor” is used to describe an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals.

In some embodiments, the “processor” can be embodied in an application specific integrated circuit (ASIC), which can be an analog ASIC or a digital ASIC. In some embodiments, the “processor” can be embodied in a microprocessor with associated program memory. In some embodiments, the “processor” can be embodied in a discrete electronic circuit, which can be analog or digital.

As used herein, the term “module” can be used to describe a “processor.” However, the term “module” is used more generally to describe any circuit that can transform an input signal into an output signal that is different than the input signal.

A processor can contain internal processors or internal modules that perform portions of the function, operation, or sequence of operations of the processor. Similarly, a module can contain internal processors or internal modules that perform portions of the function, operation, or sequence of operations of the module.

While electronic circuits shown in figures herein may be shown in the form of analog blocks or digital blocks (e.g., processors or modules), it will be understood that the analog blocks can be replaced by digital blocks (e.g., processors or modules) that perform the same or similar functions and the digital blocks can be replaced by analog blocks that perform the same or similar functions. Analog-to-digital or digital-to-analog conversions may not be explicitly shown in the figures, but should be understood.

In particular, it should be understood that a so-called comparator can be comprised of an analog comparator having a two-state output signal indicative of an input signal being above or below a threshold level (or indicative of one input signal being above or below another input signal). However, the comparator can also be comprised of a digital circuit (e.g., processor or module) having an output signal or value with at least two states indicative of an input signal or value being above or below a threshold level (or indicative of one input signal or value being above or below another input signal or value), respectively, or a digital signal or value above or below a digital threshold signal or value (or another digital signal or value), respectively.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

As used herein, the terms “line” and “linear” are used to describe either a straight line or a curved line. The line can be described by a function having any order less than infinite.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

1. A device, comprising:
a magnet portion; and
a cap comprising a metallic material, wherein the cap has an end with a slant, wherein the magnet portion is at least partially embedded in the cap.

2. The device according to claim 1, wherein the magnet portion comprises a cylindrical shape.

3. The device according to claim 1, wherein an angle of the slant ranges from 1 degree to 45 degrees inclusive.

4. The device according to claim 1, wherein the magnet portion is completely embedded in the cap.

5. The device according to claim 1, wherein a surface of the magnet portion has the same slant angle as the end surface of the cap.

6. The device according to claim 5, wherein the slanted surface of the magnet portion and the slanted end surface of the cap form a linear surface of the device.

7. The device according to claim 6, wherein the magnet portion comprises a cylindrical magnet positioned in a center of the cap, wherein the cap has a cylindrical shape.

8. The device according to claim 6, wherein the magnet is exposed at opposing end surfaces of the cylindrical magnet.

9. The device according to claim 1, wherein the magnet portion comprises a cylindrical magnet with top and bottom surfaces parallel to each other, and wherein the slanted surface of the cap covers the top surface of the cylindrical magnet.

10. The device according to claim 1, wherein the device is configured as a target for end of shaft angle sensing.

11. The device according to claim 10, wherein the magnet portion is configured as a target for magnetic field sensing and the cap is configured as a target for inductive sensing.

12. A method, comprising:
providing a magnet portion; and
a cap comprising a metallic material, wherein the cap has an end with a slant, wherein the magnet portion is at least partially embedded in the cap.

13. The method according to claim 12, wherein the magnet portion comprises a cylindrical shape.

14. The method according to claim 12, wherein an angle of the slant ranges from 1 degree to 45 degrees inclusive.

15. The method according to claim 12, wherein a surface of the magnet portion has the same slant angle as the end surface of the cap.

16. The device according to claim 15, wherein the slanted surface of the magnet portion and the slanted end surface of the cap form a linear surface of the device.

17. The method according to claim 16, wherein the magnet portion comprises a cylindrical magnet positioned in a center of the cap, wherein the cap has a cylindrical shape.

18. The method according to claim 12, wherein the magnet portion comprises a cylindrical magnet with top and bottom surfaces parallel to each other, and wherein the slanted surface of the cap covers the top surface of the cylindrical magnet.

19. The method according to claim 12, wherein the device is configured as a target for end of shaft angle sensing.

20. The method according to claim 19, wherein the magnet portion is configured as a target for magnetic field sensing and the cap is configured as a target for inductive sensing.
